(19) United States
(12) Patent Application Publication
(10) Pub. No.: US 2021/0159494 A1
(43) Pub. Date: May 27, 2021

(54) LIQUID COMPOSITION, METHOD OF DISCHARGING LIQUID, METHOD OF MANUFACTURING ELECTRODE, AND METHOD OF MANUFACTURING ELECTROCHEMICAL DEVICE

(71) Applicants: Ryuji HIGASHI, Kanagawa (JP); Kohji MATSUOKA, Kanagawa (JP); Masahiro MASUZAWA, Kanagawa (JP); Yuko HAYAMA, Kanagawa (JP); Hideo YANAGITA, Tokyo (JP)

(72) Inventors: Ryuji HIGASHI, Kanagawa (JP); Kohji MATSUOKA, Kanagawa (JP); Masahiro MASUZAWA, Kanagawa (JP); Yuko HAYAMA, Kanagawa (JP); Hideo YANAGITA, Tokyo (JP)

(21) Appl. No.: 17/100,210

(22) Filed: Nov. 20, 2020

(30) Foreign Application Priority Data
Nov. 25, 2019 (JP) 2019-212693

(51) Int. Cl. H01M 4/48; H01M 4/04; H01M 4/62; H01M 4/139; H01M 10/0525

(52) U.S. Cl. CPC H01M 4/48; H01M 4/0404; H01M 2004/021; H01M 4/139; H01M 10/0525; H01M 4/622

(57) ABSTRACT

The present invention relates to a liquid composition including particles and a solvent, wherein a diffusion coefficient of the liquid composition decreases in one step-shaped curve through a single inflection point as content of the particles increases, and wherein the content of the particles is greater than or equal to the content of the particles at the inflection point.

### CROSS-REFERENCE TO RELATED APPLICATIONS

The present application claims priority under 35 U.S.C. § 119 to Japanese Patent Application No. 2019-212693, filed Nov. 25, 2019. The contents of which are incorporated herein by reference in their entirety.

### BACKGROUND OF THE INVENTION

### Field of the Invention

The present invention relates to a liquid composition, a method of discharging liquid, a method of manufacturing an electrode, and a method of manufacturing an electrochemical device.

### Description of the Related Art

In recent years, there has been shifting to a use of liquid compositions containing pigments to improve the weather resistance of images formed by methods of discharging liquid. In addition, there is strong demand for image quality equivalent to that of silver salt photographs, and there is especially great demand for improved image density and improved image uniformity.

Under these circumstances, various suggestions have been proposed to improve image density.

As one of the proposals for a coating medium, a method of applying a filler material or a sizing agent to a surface of a base paper has been proposed. For example, a method of forming a receiving layer by applying porous particles that adsorb pigments to a base paper as a filler material has been known.

However, there is a high demand to form images with high image density on plain paper that is relatively inexpensive and readily available, and many considerations have been proposed.

### RELATED-ART DOCUMENT

### Patent Documents

Patent Document 1: Japanese Unexamined Patent Application Publication No. 2003-39810

Patent Document 2: Japanese Unexamined Patent Application Publication 2006-173001

Patent Document 1 discloses an ink set including an aqueous ink containing at least an ultrafinely particulate pigment as a coloring material and an aqueous liquid composition containing fine particles dispersed therein and electrically charged at the surface in a polarity opposite to the ink, in a dispersed state.

Conventionally, in electrochemical devices such as lithium-ion secondary batteries, electric double layer capacitors, lithium-ion capacitors, and redox capacitors, a separator, such as paper, non-woven fabric, and porous film, is used for conducting ions while preventing short circuits between the positive-electrode and negative-electrode.

Nowadays, an electrode-integrated separator in which a particle layer is formed on the electrode composite material layer is used (see, for example, Patent Document 2).

Electrode-integrated separators are typically manufactured by applying particles and liquid compositions containing solvents onto an electrode composite material layer that is a coating medium having a porous structure.

### SUMMARY OF THE INVENTION

### Problems to be Solved by the Invention

However, since the electrode composite material layer is the coating medium having a porous structure, there is a concern that when the liquid composition is applied onto the electrode composite material layer, the particles will penetrate the electrode composite material layer as the solvent permeates the electrode composite material layer, causing the separator to be thinner, and thereby reducing the electrical resistance between the positive-electrode (or negative-electrode) and the negative-electrode (or positive-electrode) of an integrated separator.

An object of the present invention is to provide a liquid composition that can be discharged from a liquid discharge head and that is capable of suppressing penetration into a coating medium having a porous structure.

### Means for Solving the Problems

One aspect of the present invention is a liquid composition including particles and a solvent, wherein a diffusion coefficient of the liquid composition decreases in a one-step shaped curve through a single inflection point as content of the particles increases, wherein the content of the particles is greater than or equal to the content of the particles at the inflection point.

### Effects of the Invention

According to the present invention, a liquid composition that can be discharged from a liquid discharge head and that can suppress penetration into the coating medium having a porous structure can be provided.

### BRIEF DESCRIPTION OF THE DRAWINGS

FIG. 1 illustrates a relationship between content of particles and a diffusion coefficient D of a liquid composition of the present embodiment;

FIG. 2 is a cross-sectional view illustrating an example of an electrochemical device of the present embodiment;

FIG. 3 is a schematic view illustrating an example of a method of manufacturing a negative-electrode of the present embodiment;

FIG. 4 is a schematic view illustrating another example of a method of manufacturing the negative-electrode of the present embodiment; and

FIG. 5 is a schematic view illustrating a modification example of a liquid discharge device of FIGS. 3 and 4.

### DESCRIPTION OF THE EMBODIMENTS

Hereinafter, embodiments of the present invention will be described.

### [Liquid Composition]

The liquid composition of the present embodiment includes particles and a solvent.

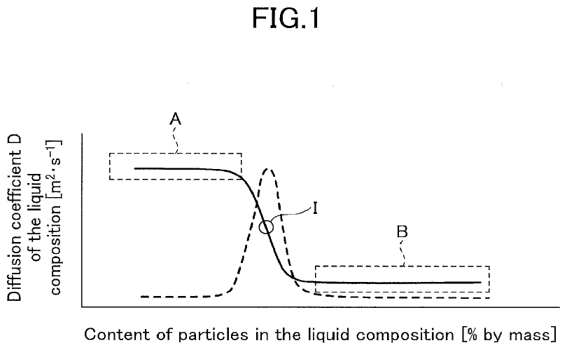

The liquid composition of the present embodiment decreases a diffusion coefficient D of the liquid composition decreases in a one-step shaped curve through a single inflection point as content of the particles increases (see FIG. 1). In FIG. 1, the dotted line indicates a differential curve, and the inflection point I is determined from the maximum value of the differential curve.

In the liquid composition of the present embodiment, content of particles is greater than or equal to content of the particles at the inflection point I (e.g., within the range of region B). If the content of the particles in the liquid composition is less than the content of the particles at the inflection point I (e.g., within the range of region A), the liquid composition is more likely to permeate the electrode composite material layer.

Here, the diffusion coefficient D of the liquid composition is considered to be an indicator of the mobility of the particles. Thus, a low diffusion coefficient D of the liquid composition is assumed to indicate low mobility of the particles.

If the diffusion coefficient D of the liquid composition decreases linearly as content of the particles increases in the liquid composition, it can be assumed that the distance between the particles shortens.

However, as illustrated in FIG. 1, if the diffusion coefficient D decreases in a one-step shaped curve through a single inflection point I as the content of particles increases, it is considered that the structure transition of the liquid composition occurred at the inflection point I, not that the distance between the particles is shortened.

For example, it is assumed that the particles are independently dispersed in region A, and that a structure of particles is formed in region B.

In region A, whether the particles are independently dispersed can be determined by measuring the particle diameter distribution of the liquid composition.

The particle diameter distribution of the liquid composition can be determined using, for example, a Fiber-Optics Particle Analyzer FPAR-1000 (manufactured by Otsuka Electronics Co., Ltd.).

Thus, in the liquid composition of the present embodiment, the structure transition of particles occurs as the content of particles increases. Also, in the liquid composition of the present embodiment, the mobility of particles is low, because the content of particles is greater than or equal to the content of particles at the inflection point I. Therefore, improvement of the mobility of particles can be observed if the liquid composition of the present embodiment is diluted.

A diffusion coefficient D of the liquid composition is calculated from the Stokes-Einstein equation:

D=(K_{B}T)/(3πηd)

where d is the particle diameter of the liquid composition, η is the solvent viscosity, T is the temperature, and K_{B} is the Boltzman constant.

The particle diameter corresponding to 90% in the liquid composition of the present embodiment is preferably 5 μm or less.

The particle diameter corresponding to 90% in the liquid composition is the particle diameter corresponding to 90% cumulative particle size distribution, measured when the content of particles is diluted to 10% by mass or less.

The liquid composition of the present embodiment has a structure of particles. Here, a structure of particles refers to a particle assembly formed by the agglomeration of a plurality of primary particles.

A plurality of primary particles is usually associated by forming non-covalent bonds such as ionic interconnections, hydrogen bonds, van der Waals forces, and the like, but may be aggregated by other than non-covalent bonds or may be associated by relatively weak bonds. As used herein, a relatively weak bond refers a bond having a bond strength sufficient to disrupt an agglomeration of particles when a liquid composition is diluted. The disagglomeration of the particles by dilution of the liquid composition can be confirmed by the presence or absence of abrupt shifts of a baseline (an average value of monotonous variation, or a regression line obtained by least-squares method, or the like) in the relationship between the content of particles and diffusion coefficient D of the liquid composition (see FIG. 1). An abrupt shift in the baseline refers that the agglomeration of the particles is disaggregated by diluting the liquid composition. The abrupt shift here refers to the baseline changes when the diffusion coefficient D changes by 10% or more with respect to the case where the content of particles changes by about 10%.

Here, the particle diameter corresponding to 90% in the liquid composition of the present embodiment being 5 μm or less indicates that the distance between particles in the particle structure is greater than the energy barrier described in the DLVO theory, and generally indicates that the particle structure is capable of being disagglomerated by dilution of about 10% by mass.

It is more preferable that the particle diameter corresponding to 90% in the liquid composition of the present embodiment is 2 μm or less from the viewpoint of discharge stability.

The median diameter of the liquid composition of the present embodiment is preferably 0.2 μm or more and more preferably 0.3 μm or more from the viewpoint of preventing penetration of the particles into the coating medium having the porous structure.

The image density is also known as optical density, and by suppressing the permeation of the liquid composition into the coating medium having the porous structure, the optical density is increased.

Accordingly, when the liquid composition of the present embodiment is discharged to the coating medium having the porous structure, the thickness of the particle layer tends to increase because the permeation of the liquid composition into the coating medium is low. As a result, a particle layer with uniform thickness and high surface resistance can be obtained, and therefore, liquid compositions of the present embodiment can be used in manufacturing separator integrated electrodes.

Generally, the dynamic viscosity of the liquid composition used in the method of discharging liquid composition is preferably 30 mPa·s or less in terms of discharge stability.

The dynamic viscosity of the liquid composition can be measured, for example, by rotating the cone plate CPE-40 at 100 rpm (equivalent to 250 mm/sec) at 25° C. using a DV-II+Pro Viscometer (manufactured by Brookfield Engineering Laboratories, Inc.).

The permeability of the liquid composition is considered to correlate with viscosity. The permeation depth 1 of the liquid composition is, for example, represented by Lucas-Washburn formula:

l=((t×r×γ×cos θ)/2η)^{1/2}

where t is time, r is the pore diameter of the coating medium having a porous structure, θ is the contact angle, and η is the viscosity of the liquid composition. This indicates that the permeation depth l of the liquid composition is inversely proportional to the viscosity η of the liquid composition to the one-half power.

Accordingly, the liquid composition in the low viscosity region applied to the method of discharging liquid composition essentially tends to permeate the coating medium having a porous structure.

However, in the liquid composition of the present embodiment, although the liquid composition can be discharged by the method of discharging liquid, the permeation into the coating medium having the porous structure can be suppressed. Although the detailed mechanism is unknown, in the liquid composition of the present embodiment, the dynamic viscosity, static viscosity (Quickly stop a rotation and measure a viscosity. Hereinafter also referred to as “quick stop”), and static viscosity (Re-rotate and measure a viscosity, hereinafter also referred to as “re-rotate”) are measured and analyzed as described below. Based on the measurements and analysis, it is assumed that the liquid composition has a low viscosity in the nozzle of the liquid discharge head under also known as high shear force. However, the structure of particles is formed under the stationary state on the coating medium having the porous structure, and the viscosity of the liquid composition on the coating medium is high. Therefore, it is assumed that the permeation into the coating medium having the porous structure is suppressed.

The absolute value of the zeta-potential of the liquid composition of the present embodiment is preferably 30 mV or less, more preferably 20 mV or less, and even more preferably 10 mV or less.

Generally, when the absolute value of the zeta-potential of the liquid composition is 30 mV or less, the structure of particles is easily formed by the electric bilayer. Therefore, the liquid composition is unlikely to permeate the coating medium having the porous structure, and thus the image density is improved.

The zeta-potential of the liquid composition is calculated from the mobility of particles measured in the liquid composition.

### [Particles]

Particles refer to solid particles with low solubility in solvents. Here, the solubility of the particles in the solvent is less than 0.1% by mass.

Examples of the materials constituting the particles include inorganic materials such as carbon, aluminum oxide, silica, calcium carbonate, titanium oxide, calcium phosphate, titanium oxide, silicon oxide, zirconium oxide, and the like; organic materials such as azo, phthalocyanine, quinacridone, and the like; and resins such as polystyrene, melamine resin, and the like. Among these, from the viewpoint of insulation and heat resistance, aluminum oxide and silica are preferably used, and α-alumina is more preferably used.

The α-alumina can function as a “junk” species, that is, a scavenger for species that can cause a capacitive fade in a lithium-ion secondary battery. In addition, the alumina particles have good wettability and affinity for the electrolyte, and the cycle performance of the lithium-ion secondary battery is improved.

The average particle diameter of the particles is preferably from about 50 nm to about 1,000 nm, preferably from about 50 nm to about 800 nm, and even more preferably from about 100 nm to about 600 nm. When the average particle diameter is about 50 nm or more, the image density is improved, and when the average particle diameter is about 1,000 nm or less, the discharge performance of the liquid composition of the present embodiment is improved, and the surface smoothness of the image is improved.

Examples of the shape of the particles include a rectangular, spherical, elliptical, cylindrical, oval, dogbone-like shape, amorphous shape, or the like.

The particles may be fibrous.

### [Solvent]

A solvent refers to water or non-aqueous solvent.

Examples of non-aqueous solvents include styrene, toluene, xylene, methyl ethyl ketone, ethyl acetate, acetone, methanol, ethanol, n-propanol, isopropanol (IPA), n-butanol, isobutanol, ter-butanol, n-pentanol, n-hexanol, diacetone alcohol, N,N-dimethylformamide (DMF), N,N-dimethyl sulfoxide (DMSO), N-methylpyrrolidone (NMP), tetrahydrofuran (THF), and the like.

The liquid composition of the present embodiment is considered to form a structure of particles, but the surface of the particles and the affinity of the solvent are considered important for controlling the structure of particles.

Thus, the solvent can be used alone, or a combination of solvents can be used.

### [Resin Containing Acid Anhydride Group]

Preferably, the liquid composition of the present embodiment further includes a resin having an acid anhydride group.

In general, the surface of the inorganic particles is charged in a solvent. When a polymer dispersant and inorganic particles coexist in a solvent, the polar groups of the polymer dispersant often adsorb to the surface of the inorganic particles due to interactions such as hydrogen bonding, ionic interactions, hydrophilic-hydrophobic interactions, and the like. When the polar group of the polymer dispersant is an ionic group such as a sulfonic acid group, a carboxylic acid group, a phosphonic acid group, or an amino group, the polar group of the polymer dispersant is often adsorbed to the surface of the inorganic particles due to ionic interaction, and in this case, the zeta-potential of the liquid composition tends to increase.

Examples of polar groups of the polymer dispersant include an acid anhydride group, a carboxylic acid ester group, an amide group, an epoxy group, an ether group, and the like. Among these, the acid anhydride group is preferred in view of adsorption and ionic interaction with inorganic particles such as alumina particles, boehmite particles, apatite particles, titanium oxide particles, silica particles, and the like.

The mass ratio of the polymer dispersant to the inorganic particles is normally 0.01 to 10. When considering the dispersibility of the inorganic particles, the mass ratio is preferably 0.1 to 10. When considering the liquid trapping property of the separator integrated electrode, the mass ratio is more preferably 0.1 to 1 and even more preferably 0.1 to 0.5.

Polymer indicates that that the number average molecular weight (Mn) is 1,000 to 100,000.

The number average molecular weight (Mn) of the polymer dispersant is preferably in the range of 1,000 to 10,000, and more preferably in the range of 1,000 to 5,000, when considering the viscosity of the liquid composition.

It is preferable that the polymer dispersant contains any of the structural units represented by the following chemical formulae from the viewpoint of dispersion stability of the liquid composition.

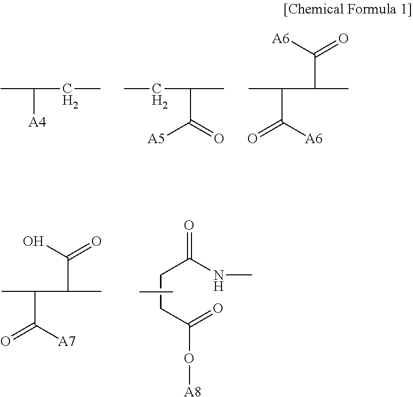

wherein A4 is a group represented by the general formula:

—O—R or —CH₂—OR

A5, A6, and A7 are groups represented by the general formula:

—OR or —NH—R

R is a linear or branched chain hydrocarbon group or oligoether group of 1 to 24 carbon atoms, and A8 is a linear or branched chain hydrocarbon group or oligoether group of 1 to 24 carbon atoms.

An oligoether group is a group having oxyethylene group or oxypropylene group as constituent unit.

The molecular weight of the oligoether group is preferably from 100 to 10,000, and more preferably from 100 to 5,000. When the molecular weight of the oligoether group is 100 or more, the dispersibility of the polymer dispersant is improved. When the molecular weight is 10,000 or less, the viscosity of the liquid composition is not easily increased.

The end of the oligoether group may be a hydroxyl group, a methoxy group, an ethoxy group, a propoxy group, and the like.

Specific examples of structural units having oligoether groups are present below. Here, n is the degree of polymerization.

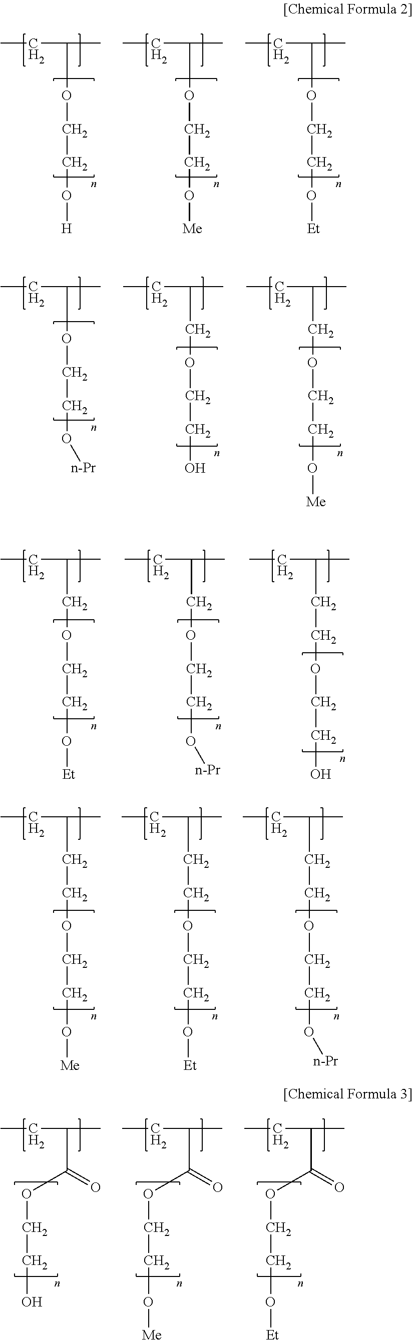

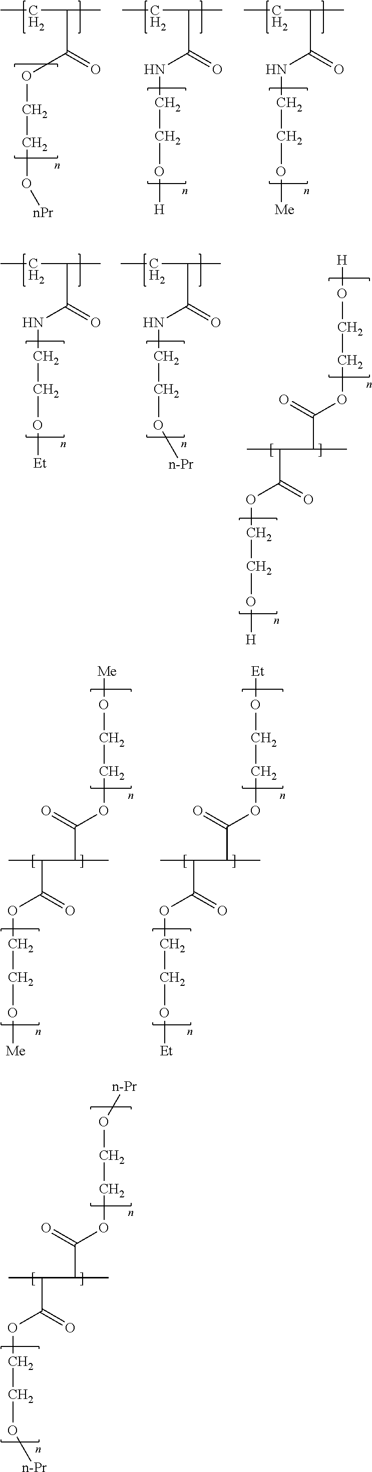

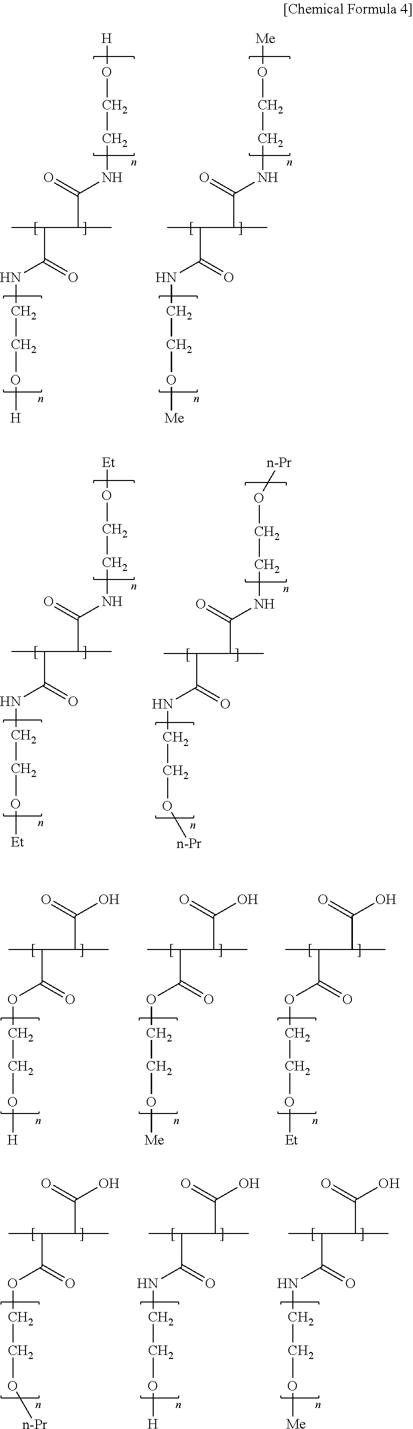

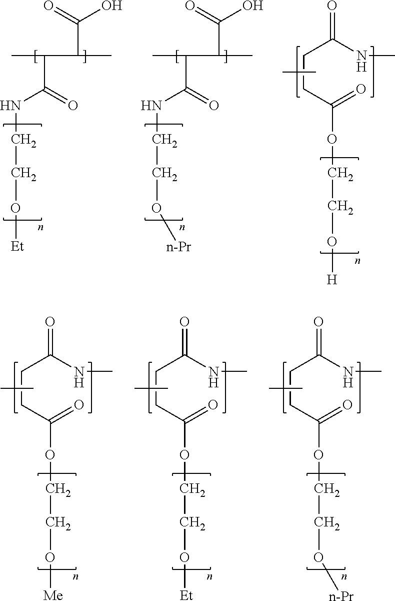

The use of a polymer dispersant having an oligoether group improves the dispersibility of a liquid composition containing a highly polar solvent.

Examples of highly polar solvents include methanol, ethanol, propanol, butanol, pentanol, hexanol, ethylene glycol, hexylene glycol, NMP, DMSO, DMF, acetone, THF, and the like.

### [Other Ingredients]

The liquid composition of the present embodiment may further include surfactants, pH regulators, rust control agents, antiseptics, antimold agents, antioxidants, antireductants, evaporation promoters, chelating agents, and the like for the purpose of adjusting viscosity, adjusting surface tension, controlling evaporation of non-aqueous solvents, improving solubility of additives, improving dispersibility of particles, sterilizing, and the like.

The liquid composition of the present embodiment may further include a resin or the like for the purpose of improving abrasivity of the particle layer and adhesion to the substrate.

Preferably, the resin is a resin emulsion or resin particle from the viewpoint of discharge performance of the liquid composition.

Examples of the resin include styrene, polyethylene glycol, polyester, styrene-butadiene rubber (SBR), acrylic resin, urethane resin, polyvinylpyrrolidone (PVP), polyvinylidene fluoride (PVDF), and the like.

The liquid composition of the present embodiment may further comprise a monomer and a polymerization initiator as a precursor of the resin. In this case, the resin is produced by heating or irradiating the liquid composition of the present embodiment with light.

### [Method of Preparation of Liquid Compositions]

The liquid compositions of the present embodiment can be prepared using a dispersion device.

Examples of dispersion devices include agitators, ball mills, bead mills, ring-type mills, high-pressure dispersers, rotary high-speed shearing devices, ultrasonic dispersors, and the like.

The liquid compositions of the present embodiment may be used alone or in combination with multiple liquid compositions.

### [Method of Use of Liquid Composition]

The liquid composition of the present embodiment is applied to the coating medium for use.

Examples of the method of applying the liquid composition include dip coating, spray coating, spin coating, bar coating, slot die coating, doctor blade coating, offset printing, gravure printing, flexographic printing, lithographic printing, screen printing, liquid discharging, and electrophotographic printing by liquid development method. Among these, the liquid discharging method is preferable in that the point where the droplets are discharged can be precisely controlled.

When a method of discharging liquid is adopted, the liquid composition is discharged from the liquid discharge head onto the coating medium.

Examples of methods for discharging the liquid composition include applying mechanical energy to the liquid composition, applying thermal energy to the liquid composition, and the like. Among these, when a non-aqueous solvent is used, a method of applying mechanical energy to the liquid composition is preferably adopted.

When a method of discharging liquid is used, a known liquid discharge device can be used.

### [Coating Medium]

The coating medium is a medium (porous) capable of absorbing the liquid composition of the present embodiment.

Examples of the coating medium include a medium in which the plain paper and a base paper are coated with porous particles, and an ink receiving layer is formed.

When an electrode in which an electrode composite material layer is formed on the electrode substrate is used as the coating medium, a separator integrated electrode or the like can be manufactured.

Examples of the coating medium other than the above include the underlayer used for the reflection display element, the electrode layer used for the printed electronics, and the like.

### [Active Material]

As an active material, a positive-electrode active material or a negative-electrode active material can be used.

The positive-electrode active material or the negative-electrode active material may be used alone or in combination with two or more kinds of active material.

Although, there is no particular limitation, the alkali metal containing transition metal compound can be used as the positive-electrode active material, if the positive-electrode active material is capable of intercalating or deintercalating the alkali metal ion.

Examples of alkali metal-containing transition metal compounds include lithium-containing transition metal compounds such as complex oxides containing lithium and one or more elements selected from the group consisting of cobalt, manganese, nickel, chromium, iron, and vanadium.

Examples of lithium-containing transition metal compounds include lithium cobaltate, lithium nickelate, lithium manganate, and the like.

As the alkali metal containing transition metal compound, a polyanionic compound having an XO₄ tetrahedra (X═P, S, As, Mo, W, Si, and the like) in the crystalline structure can also be used. Among these, lithium-containing transition metal phosphate compounds, such as lithium iron phosphate and lithium vanadium phosphate, are preferably used from the viewpoint of cycle characteristics, and vanadium lithium phosphate is particularly preferably used from the viewpoint of lithium diffusion coefficient and output characteristics.

The surface of the polyanionic-based compound is preferably coated with a conductive aid such as a carbon material and composited in terms of electron conductivity.

Although, there is no particular limitation, a carbon material containing graphite having a graphite crystalline structure can be used as the negative active material, if the negative active material is capable of intercalating or deintercalating alkali metal ions.

Examples of the carbon material include natural graphite, artificial graphite, non-graphitizable carbon (hard carbon), highly graphitizable carbon (soft carbon), and the like.

Examples of the negative-electrode active material other than the carbon material include lithium titanate, titanium oxide, and the like.

High-capacity materials such as silicon, tin, silicon alloy, tin alloy, silicon oxide, silicon nitride, and tin oxide is preferably used as the negative-electrode active material in terms of energy density of the non-aqueous storage device.

### [Dispersion Medium]

Examples of the dispersion medium include an aqueous dispersion medium such as water, ethylene glycol, propylene glycol, and the like; an organic dispersion medium such as N-methyl-2-pyrrolidone, 2-pyrrolidone, cyclohexanone, butyl acetate, mesitylene, 2-n-butoxymethanol, 2-dimethyl ethanol, N,N-dimethylacetamide, and the like. Two or more kinds of the dispersion medium may be used together.

### [Conductive Aid]

For example, a conductive carbon black manufactured by a furnace method, an acetylene method, or a gasification method, or a carbon material such as carbon nanofibers, carbon nanotubes, graphene, or graphite powder can be used as a conductive aid. For example, a metal particle, such as aluminum, or a metal fiber can be used as a conductive aid other than a carbon material. The conductive aid can be pre-complexed with the active material.

### [Dispersant]

Examples of the dispersant include polymer dispersants such as a polycarboxylic acid-based dispersant, a naphthalene sulfonate-based formalin condensation-based dispersant, a polyethylene glycol, a polycarboxylic acid-partial alkyl ester-based dispersant, a polyether-based dispersant, a polyalkylene polyamine-based dispersant, and the like; surfactants such as an alkyl sulfonate-based dispersant, a quaternary ammonium salt-based dispersant, a high-grade alcohol alkylene oxide-based dispersant, a polyhydric alcohol ester-based dispersant, an alkyl polyamine-based dispersant; and an inorganic dispersant such as a polyphosphate-based dispersant.

### [Electrochemical Device]

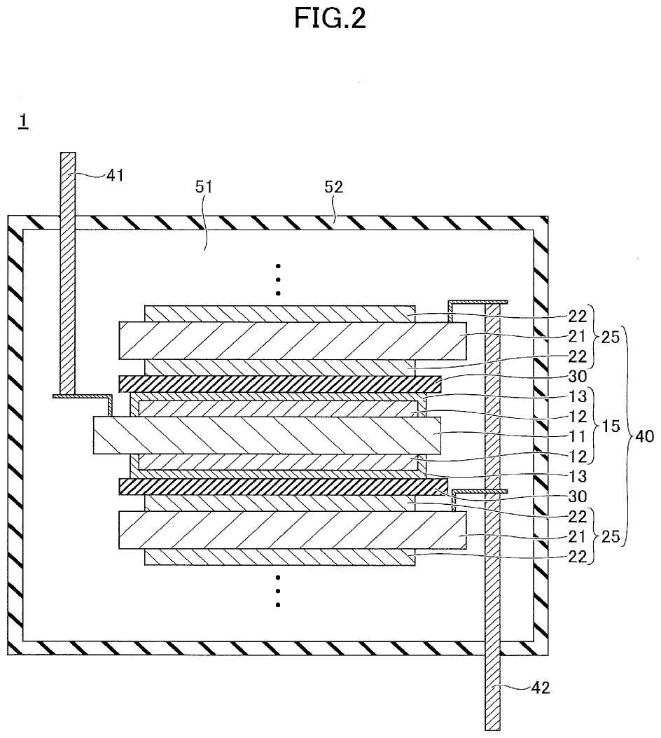

FIG. 2 illustrates an example of an electrochemical device of the present embodiment.

In an electrochemical device 1, an electrolyte layer 51 constituted by an electrolyte aqueous solution or a non-aqueous electrolyte is formed on an electrode element 40 and sealed by an outer sheath 52. In the electrochemical device 1, lead lines 41 and 42 are drawn out of the outer sheath 52.

In the electrode element 40, a negative-electrode 15 and a positive-electrode 25 are laminated through a separator 30. Here, the positive-electrode 25 is laminated to both sides of the negative-electrode 15. A lead line 41 is connected to a negative-electrode substrate 11, and a lead line 42 is connected to a positive-electrode substrate 21.

In the negative-electrode 15, a negative-electrode composite material layer 12 and a particle layer 13 are sequentially formed on both sides of the negative-electrode substrate 11.

In the positive-electrode 25, a positive-electrode composite material layer 22 is formed on both sides of the positive-electrode substrate 21.

Here, the positive-electrode composite material layer 22 and the particle layer may be sequentially formed on both sides of the positive-electrode substrate 21. In this case, the particle layer 13 may be omitted, as needed.

The number of layers of the negative-electrode 15 and the positive-electrode 25 in the electrode element 40 is not particularly limited.

The number of the negative-electrode 15 and the number of the positive-electrode 25 in the electrode element 40 may be the same or may be different.

The electrochemical device 1 may have other parts as needed.

The type of the electrochemical device 1 is not particularly limited. Examples of the electrochemical device 1 include a laminate type, a cylinder type in which a sheet electrode and a separator are spiraled, a cylinder type with an in-side out structure in which a pellet electrode and a separator are combined, and a coin type in which a pellet electrode and a separator are laminated.

Examples of the electrochemical device 1 include a water-based battery element and a non-water-based battery element.

### [Separator]

The separator 30 is provided between the negative-electrode 15 and the positive-electrode 25 as needed to prevent short circuiting of the negative-electrode 15 and the positive-electrode 25.

Examples of the separator 30 include paper such as kraft paper, vinylon mixed paper, synthetic pulp mixed paper, polyolefin non-woven fabric such as cellophane, polyethylene graft film, polypropylene meltblown non-woven fabric, polyamide non-woven fabric, glass fiber non-woven fabric, micropore membrane, and the like.

The size of the separator 30 is not particularly limited as long as the separator can be used in electrochemical devices.

The separator 30 may be a single layer structure or a laminated structure.

When a solid electrolyte is used as a non-aqueous electrolyte, the separator 30 may be omitted.

### [Electrolyte Solution]

Examples of the electrolyte salt constituting the aqueous electrolyte solution include sodium hydroxide, potassium hydroxide, sodium chloride, potassium chloride, ammonium chloride, zinc chloride, zinc acetate, zinc bromide, zinc iodide, zinc tartrate, zinc perchlorate, and the like.

### [Non-Aqueous Electrolyte]

As the non-aqueous electrolyte, a solid electrolyte or a non-aqueous electrolyte can be used.

Here, the non-aqueous electrolyte solution is an electrolyte solution in which the electrolyte salt is dissolved in the non-aqueous solvent.

### [Non-Aqueous Solvents]

A non-aqueous solvent is not particularly limited. For example, an aprotic organic solvent is preferably used.

As the aprotic organic solvent, carbonate-based organic solvents such as a chain carbonate or a cyclic carbonate can be used. Of these, a chain carbonate is preferably used because of the high solubility of the electrolyte salt.

Preferably, the aprotic organic solvent has a low viscosity.

Examples of the chain carbonate include dimethyl carbonate (DMC), diethyl carbonate (DEC), methyl ethyl carbonate (EMC), and the like.

The content of the chain carbonate in the non-aqueous solvent is preferably 50% by mass or more. When the content of the chain carbonate in the non-aqueous solvent is 50% by mass or more, the content of cyclic material is reduced even when the non-aqueous solvent other than the chain carbonate is a cyclic material with a high dielectric constant (e.g., cyclic carbonate, cyclic ester). Therefore, even when a non-aqueous electrolytic solution having a high concentration of 2 M or more is prepared, the viscosity of the non-aqueous electrolytic solution decreases, and impregnation and ion diffusion into the electrode of the non-aqueous electrolytic solution becomes favorable.

Examples of the cyclic carbonate include propylene carbonate (PC), ethylene carbonate (EC), butylene carbonate (BC), vinylene carbonate (VC), and the like.

The non-aqueous solvent other than the carbonate organic solvent includes, for example, ester-based organic solvents such as a cyclic ester or a chain ester, ether-based organic solvents such as a cyclic ether or a chain ether, or the like.

Examples of cyclic esters include γ-butyrolactone (γBL), 2-methyl-γ-butyrolactone, acetyl-γ-butyrolactone, γ-valerolactone, and the like.

Examples of chain esters include propionic acid alkyl ester, malonic acid dialkyl ester, acetic acid alkyl ester (e.g., methyl acetate (MA), ethyl acetate), formic acid alkyl ester (e.g., methyl formate (MF), ethyl formate), and the like.

Examples of cyclic ethers include tetrahydrofuran, alkyltetrahydrofuran, alkoxytetrahydrofuran, dialkoxytetrahydrofuran, 1,3-dioxolane, alkyl-1,3-dioxolane, 1,4-dioxolane, and the like.

Examples of chain ethers include 1,2-dimethoxyethane (DME), diethyl ether, ethylene glycol dialkyl ether, diethylene glycol dialkyl ether, triethylene glycol dialkyl ether, tetraethylene glycol dialkyl ether, and the like.

### [Electrolyte Salt]

An electrolyte salt is not particularly limited, as long as the electrolyte salt has high ionic conductivity and can be dissolved in a non-aqueous solvent.

The electrolyte salt preferably contains a halogen atom.

Examples of the cations constituting the electrolyte salt include lithium-ions and the like.

Examples of the anions constituting the electrolyte salt include BF₄⁻, PF₆⁻, AsF₆⁻, CF₃SO₃⁻, (CF₃SO₂)₂N⁻, (C₂F₅SO₂)₂N⁻, and the like.

The lithium salts are not particularly limited and can be appropriately selected depending on the purpose. Examples of the lithium salts include lithium hexafluorophosphate (LiPF₆), lithium borofluoride (LiBF₄), lithium arsenide (LiAsF₆), lithium trifluorometasulfonate (LiCF₃SO₃), lithium bis (trifluoromethylsulfonyl) imide (LiN(CF₃SO₂)₂), lithium bis (pentafluoroethylsulfonyl) imide (LiN(C₂F₅SO₂)₂), and the like. Among these, LiPF₆ is preferably used from the viewpoint of ionic conductivity, and LiBF₄ is preferably used from the viewpoint of stability.

The electrolyte salt may be used alone or two or more kinds may be used in combination.

The concentration of the electrolyte salt in the non-aqueous electrolyte solution can be appropriately selected depending on the purpose. When the non-aqueous battery element is of the swing type, the concentration of the electrolyte salt is preferably 1 mol/L to 2 mol/L. When the non-aqueous battery element is a reservoir type, the concentration of the electrolyte salt is preferably 2 mol/L to 4 mol/L.

### [Method of Manufacturing Electrochemical Device]

A method of manufacturing an electrochemical device in accordance with the present embodiment includes forming an electrode composite material layer on an electrode substrate, and discharging a liquid composition of the present embodiment onto the electrode composite material layer to forma particle layer.

The electrode composite material layer and the particle layer may be formed on one side of the electrode substrate or may be formed on both sides of the electrode substrate.

The electrode composite material layer can be formed by applying a liquid composition for the electrode composite material layer.

The liquid composition for the electrode composite material layer may include an active material and a dispersion medium, and may optionally further include a conductive aid, a dispersant, and the like.

Examples of the method for applying the liquid composition for the electrode composite material layer include the comma coating method, the die coating method, the curtain coating method, the spray coating method, the liquid discharge method, and the like.

The method of applying the liquid composition of the present embodiment includes, for example, liquid discharge methods or the like.

### [Method of Manufacturing Negative-Electrode]

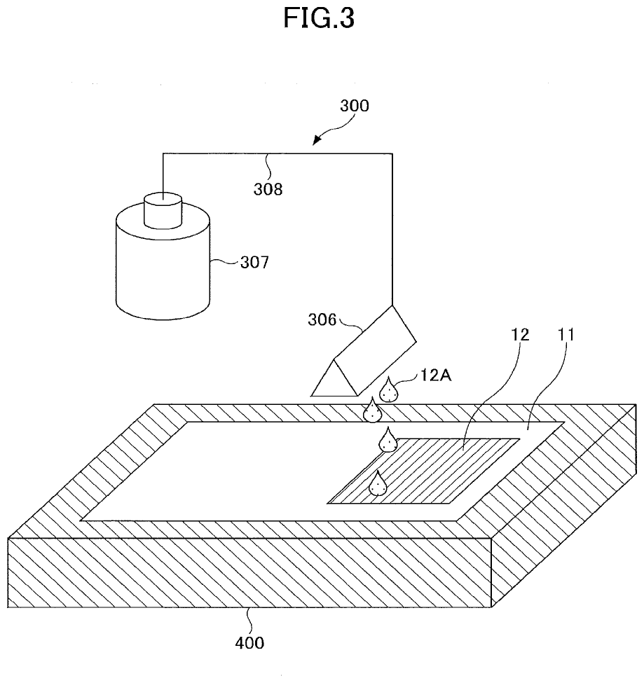

FIG. 3 illustrates an example of a method of manufacturing the negative-electrode of the present embodiment.

A method of manufacturing the negative-electrode includes discharging a liquid composition 12A onto the negative-electrode substrate 11 using a liquid discharge device 300 to form a negative-electrode composite material layer 12, and discharging the liquid composition of the present embodiment onto the negative-electrode composite material layer 12 to form the particle layer.

Here, the liquid composition 12A includes a negative active material and a dispersion medium.

The liquid composition 12A is stored in a tank 307 and supplied from the tank 307 through a tube 308 to a liquid discharge head 306.

The liquid discharge device 300 may also be provided with a mechanism to cap a nozzle to prevent drying when the liquid composition 12A is not discharged from the liquid discharge head 306.

In manufacturing the negative-electrode, the negative-electrode substrate 11 is placed on a stage 400 that can be heated. Then, the droplets of the liquid composition 12A are discharged to the negative-electrode substrate 11, and then heated to form the negative-electrode composite material layer 12. At such timing, the stage 400 may move or the liquid discharge head 306 may move.

When the liquid composition 12A discharged to the negative-electrode substrate 11 is heated, it may be heated by the stage 400 or by a heating mechanism other than the stage 400.

The type of heating mechanism is not particularly limited as long as the heating mechanism operates without direct contact with the liquid composition 12A. Examples of heating mechanisms include resistive heaters, infrared heaters, fan heaters, and the like.

A plurality of heating mechanisms may be provided.

The heating temperature is not particularly limited, but preferably in the range of 70 to 150° C. from the viewpoint of energy use.

When heating the liquid composition 12A discharged to the negative-electrode substrate 11, a UV light may be emitted.

Then, a particle layer is formed and a negative-electrode is prepared in the same manner as the negative-electrode composite material layer 12.

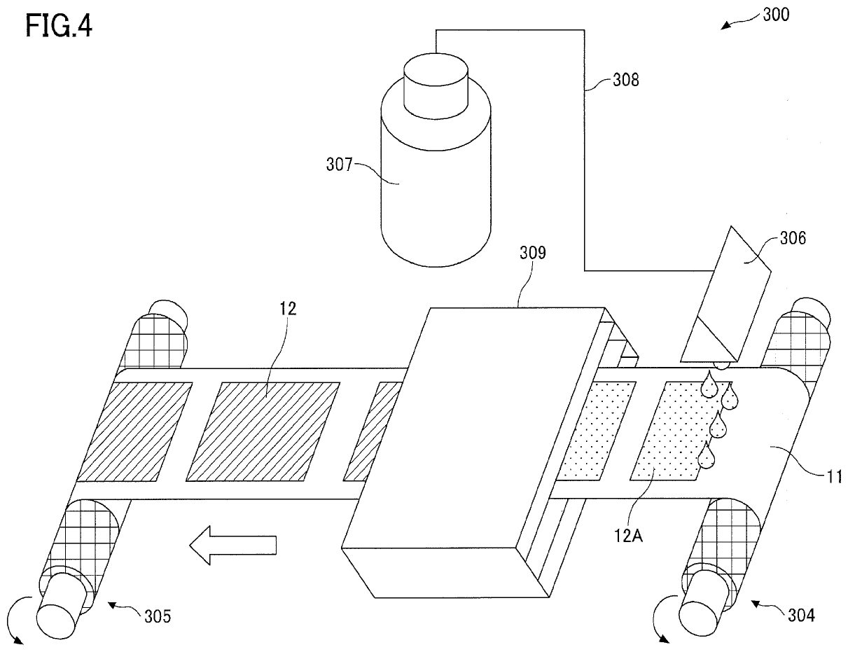

FIG. 4 illustrates another example of a method for manufacturing a negative-electrode of the present embodiment.

A method of manufacturing the negative-electrode includes discharging the liquid composition 12A onto the negative-electrode substrate 11 using the liquid discharge device 300 to form the negative-electrode composite material layer 12, and discharging the liquid composition of the present embodiment onto the negative-electrode composite material layer 12 to form the particle layer.

First, an elongate negative-electrode substrate 11 is prepared. Then, the negative-electrode substrate 11 is wound around a cylindrical core, and the side forming the negative-electrode composite material layer 12 is set to a feed roller 304 and a take-up roller 305 so as to be on the upper side in the drawing. Here, the feed roller 304 and the take-up roller 305 rotate counterclockwise, and the negative-electrode substrate 11 is conveyed in the left direction from the right side of FIG. 4. The droplets of the liquid composition 12A are discharged from the liquid discharge head 306 placed above the negative-electrode substrate 11 between the feed roller 304 and the take-up roller 305 onto the negative-electrode substrate 11 to be conveyed. The droplets of the liquid composition 12A are discharged so as to cover at least a portion of the negative-electrode substrate 11.

A plurality of liquid discharge heads 306 may be placed in a direction substantially parallel to or substantially perpendicular to the conveying direction of the negative-electrode substrate 11.

Next, the negative-electrode substrate 11 on which the liquid composition 12A is discharged is conveyed to a heating mechanism 309 by the feed roller 304 and the take-up roller 305. As a result, the liquid composition 12A on the negative-electrode substrate 11 is dried to form the negative-electrode composite material layer 12.

The type of heating mechanism 309 is not particularly limited as long as the heating mechanism operates without direct contact with the liquid composition 12A. Examples of heating mechanisms include resistive heaters, infrared heaters, fan heaters, and the like.

The heating mechanism 309 may be provided on one of the upper and lower portions of the negative-electrode substrate 11, or a plurality of the heating mechanisms may be provided.

The heating temperature is not particularly limited, but preferably is in the range of 70 to 150° C. from the viewpoint of energy use.

When heating the liquid composition 12A discharged to the negative-electrode substrate 11, a UV light may be emitted.

Then, a particle layer is formed and a negative-electrode is prepared in the same manner as the negative-electrode composite material layer 12.

Then, the negative-electrode is cut to the desired size by punching or the like.

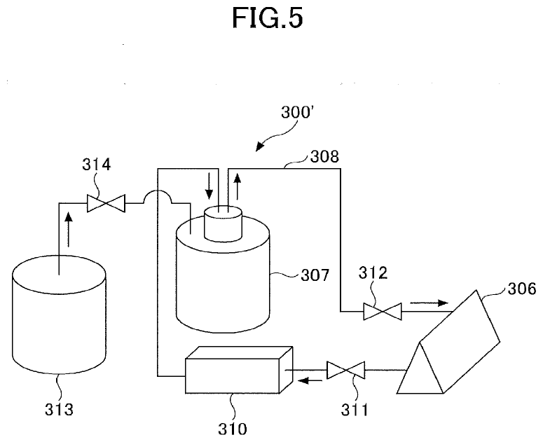

FIG. 5 illustrates a modification example of the liquid discharge device 300.

In a liquid discharge device 300′, the liquid composition 12A can circulate through the liquid discharge head 306, the tank 307, and the tube 308 by controlling a pump 310 and valves 311 and 312.

The liquid discharge device 300′ is also provided with an external tank 313, and the liquid composition 12A can be supplied from the external tank 313 to the tank 307 by controlling the pump 310 and the valves 311, 312, and 314 when the liquid composition 12A in the tank 307 is reduced.

The liquid discharge devices 300 and 300′ can be used to discharge the liquid composition 12A at the target of the negative-electrode substrate 11. Further, when the liquid discharge devices 300 and 300′ are used, surfaces that contact the negative-electrode substrate 11 and the negative-electrode composite material layer 12 can be bonded to each other. Furthermore, the thickness of the negative-electrode composite material layer 12 can be uniform using the liquid discharge devices 300 and 300′.

### [Method of Manufacturing Positive-Electrode]

The method of manufacturing the positive-electrode is the same as that of the negative-electrode, except that the liquid composition including the positive-electrode active material and the dispersion medium is discharged on the positive-electrode substrate.

The particle layer may be formed in at least one of the positive-electrode or the negative-electrode.

### [Application of Electrochemical Devices]

Applications of electrochemical devices include, but are not limited to, notebook PCs, pen input PCs, mobile PCs, electronic book players, cellular phones, portable faxes, portable copies, portable printers, headphone stereos, video movies, LCD TVs, handy cleaners, portable CDs, mini disks, transceivers, electronic pocketbooks, calculators, memory cards, portable tape recorders, radio, backup power supplies, motors, lighting fixtures, toys, game machines, clocks, strobe boxes, cameras, and the like.

### Examples

Hereinafter, examples of the present invention will be described. However, the present invention is not limited by examples unless the gist thereof is exceeded.

“Parts” and “%” are by mass unless otherwise indicated.

[Median Diameter (D₅₀), Particle Diameter Corresponding to 90% in Liquid Composition (D₉₀)]

After the liquid composition was diluted so that the solid content was 10% by mass or less, the median diameter (D₅₀), particle diameter corresponding to 90% (D₉₀) in the liquid composition were measured using a Fiber-Optics Particle Analyzer FPAR-1000 (manufactured by Otsuka Electronics Co., Ltd.).

### [Relationship Between Content of Particles and Diffusion Coefficient D in Liquid Composition]

The median diameter D₅₀ of the liquid composition was applied to the Stokes-Einstein equation d to calculate the diffusion coefficient D. The horizontal axis was then plotted as the content of the particles in the liquid composition (% by mass) and the vertical axis as the diffusion coefficient D of the liquid composition.

Here, the inflection point was determined from the maximum value of the differential curve when the diffusion coefficient D of the liquid composition decreased in a one-step shaped curve as the content of the particles in the liquid composition increased (see FIG. 1).

### [Zeta-Potential of Liquid Composition]

The zeta-potential of the liquid composition was measured using the Zeta-potential and Particle size Analyzer ELSZ-2 plus (manufactured by Otsuka Electronics Co., Ltd.) after dilution to the region of optical density with the solvent contained in the liquid composition.

### [Dynamic Viscosity of Liquid Composition]

The cone plate CPE-40 was rotated at 100 rpm at 25° C. using a DV-II+Pro Viscometer (manufactured by Brookfield Engineering Laboratories, Inc.) to measure the dynamic viscosity of the liquid composition.

### [Static Viscosity of Liquid Composition]

The static viscosity (quick stop) of the liquid composition was measured using a DV-II+Pro Viscometer (manufactured by Brookfield Engineering Laboratories, Inc.) at 25° C. by rotating the cone plate CPE-40 at 100 rpm and then rapidly decreasing to 6 rpm. The cone plate CPE-40 was then rotated at 6 rpm for 30 seconds and then stopped for 10 seconds. The cone plate CPE-40 was rotated again at 6 rpm to measure static viscosity (re-rotate).

### [Synthesis of Polymer Dispersant 1]

1 mol of 2-[2-(2-methoxyethoxy)ethoxy]ethyl acrylate (manufactured by Tokyo Chemical Industry Co., Ltd.) and 1.1 mol of maleic anhydride (manufactured by Tokyo Chemical Industry Co., Ltd.) were dissolved in 1,000 ml of dioxane followed by 0.01 mol of 2,2T-azobis (2-methylpropionitrile). Then, the mixture was stirred at 75° C. under a nitrogen atmosphere for 8 hours, and then dried under reduced pressure to prepare a polymer dispersant 1 having a number average molecular weight of 5,000.

### [Synthesis of Polymer Dispersant 2]

After 105 parts of polymer dispersant 1 was dissolved in 100 parts of dioxane, a solution in which 1.3 parts of ammonia was dissolved in water was added. Then, after heating and stirring at 100° C. for 2 hours, the mixture was dried under reduced pressure to prepare a polymer dispersant 2.

### [Synthesis of Polymer Dispersant 3]

1 mol of stearyl acrylate (manufactured by Tokyo Chemical Industry Co., Ltd.) and 1.1 mol of maleic anhydride (manufactured by Tokyo Chemical Industry Co., Ltd.) were dissolved in 100 parts of dioxane and 0.01 mol of 2,2′-azobis(2-methylpropionitrile) was added. Then, the mixture was stirred at 75° C. under a nitrogen atmosphere for 8 hours, and then dried under reduced pressure to prepare a polymer dispersant 3 having a number average molecular weight of 5,000.

### [Preparation of Liquid Compositions]

After the particles, solvent, and polymer dispersant were mixed in a predetermined ratio (see Table 1), the liquid composition was obtained by circulating the mixture twice at a rotational speed of 6 m/s using a bead mill disperser LMZ150 (manufactured by Ashizawa Finetech Ltd.) and 0.1 mm of zirconia beads.

Table 1 indicates the diffusion coefficient D, the particle diameter corresponding to 90% (D₉₀), and the zeta-potential of the liquid composition.

The abbreviations in Table 1 indicate the following.

AKP-3000: aluminum oxide particles (manufactured by Sumitomo Chemical Co., Ltd.)

LS-110: aluminum oxide particles (manufactured by Nippon Light Metal Co., Ltd.)

PT-301: titanium oxide particles (manufactured by Ishihara Sangyo Kaisha, Ltd.)

IPA: isopropyl alcohol

HG: hexylene glycol

MEK: methyl ethyl ketone

DAA: diacetone alcohol

SC-0708A: polymer polycarboxylic acid (manufactured by NOF Corporation)

The mixing ratio of the mixed solvents in Table 1 is the mass ratio.

### [Preparation of Coating Medium]

93 parts of graphite powder KS6 (manufactured by Timcal Ltd.) and 5 parts of Denka Black (Acetylene Black) (manufactured by Denka Company Ltd.) were kneaded by adding water, followed by adding 1 part of 2% by mass of aqueous solution 1270 (manufactured by Daicel Corporation) of carboxymethyl cellulose, and the mixture was kneaded. In addition, 1 part of styrene-butadiene rubber (manufactured by ZEON Corporation) was added to the previous mixture to prepare a slurry for the negative-electrode composite material layer.

A slurry for the negative-electrode composite material layer was applied to an aluminum foil as a negative-electrode substrate and then vacuum dried at 150° C. for 12 hours. Next, the negative-electrode substrate was compressed by a press (manufactured by TESTER SANGYO Co., Ltd.) to prepare a coating medium having a solids content of 3 mg/cm² per unit area and a solid content of 1.6 g/cm³ per unit volume.

### [Forming Evaluation Image]

The liquid discharge device EV2500 (manufactured by Ricoh Co., Ltd.) and the liquid discharge head 5421F (manufactured by Ricoh Co., Ltd.) were used to discharge the liquid composition onto the coating medium, and then the liquid composition was dried at 120° C. using a hot plate to form an evaluation image. The drive waveform, the drive voltage, and the number of droplets applied to the liquid discharge head were adjusted so that the content of the particles attached [mg/cm²] satisfies the following relationship:

Content of particles (% by mass)/40

### [Permeability of Liquid Composition to Coating Medium]

A portable imaging spectroscopic colorimeter, RM200 (manufactured by X-Rite Inc.), was used to measure the brightness L* of the evaluated image at 100 points, and then the average of the brightness L* of the evaluated image was obtained. Next, the average value L* (1 mg) of brightness, when the content of the particles attached was 1 mg/cm², was calculated by the following formula:

L*(1 mg)=average value of L*/content of particles attached

Then, the permeability of the liquid composition to the coating medium was evaluated.

Tables 1 to 3 indicate the evaluation results of the permeability of the liquid composition to the coating medium.

TABLE 1

| | | | | | Polymer dispersant | | | | | |
|---|---|---|---|---|---|---|---|---|---|---|
| | Particles | | | | | Mass | | | | |
| | | Content | Region | | | ratio to | D | | Zeta- | |
| | | [% by | in | | | particles | [×10⁻¹¹ | D₉₀ | potential | L*(1 |
| | Type | mass] | FIG. 1 | Solvent | Type | [%] | m²s⁻¹] | [μm] | [mV] | mg) |
| Comparative | AKP-3000 | 10 | A | IPA | SC-0708A | 5.0 | 2.5 | 1.23 | −20 | 61 |
| Example 1 | | | | | | | | | | |
| Comparative | AKP-3000 | 20 | A | IPA | SC-0708A | 5.0 | 2.7 | 1.22 | −21 | 59 |
| Example 2 | | | | | | | | | | |
| Example 1 | AKP-3000 | 30 | B | IPA | SC-0708A | 5.0 | 1.4 | 1.21 | −21 | 75 |
| Example 2 | AKP-3000 | 40 | B | IPA | SC-0708A | 5.0 | 1.3 | 1.18 | −22 | 76 |
| Example 3 | AKP-3000 | 50 | B | IPA | SC-0708A | 5.0 | 1.2 | 1.21 | −23 | 76 |
| Comparative | AKP-3000 | 10 | A | IPA/2-pyrrolidone (4:1) | Polymer dispersant 1 | 5.0 | 2.2 | 3.21 | −21 | 60 |
| Example 3 | | | | | | | | | | |
| Comparative | AKP-3000 | 20 | A | IPA/2-pyrrolidone (4:1) | Polymer dispersant 1 | 5.0 | 2.1 | 3.18 | −22 | 58 |
| Example 4 | | | | | | | | | | |
| Example 4 | AKP-3000 | 30 | B | IPA/2-pyrrolidone (4:1) | Polymer dispersant 1 | 5.0 | 1.3 | 3.15 | −22 | 74 |
| Example 5 | AKP-3000 | 40 | B | IPA/2-pyrrolidone (4:1) | Polymer dispersant 1 | 5.0 | 1.2 | 3.19 | −21 | 73 |
| Example 6 | AKP-3000 | 50 | B | IPA/2-pyrrolidone (4:1) | Polymer dispersant 1 | 5.0 | 1.3 | 3.18 | −32 | 74 |
| Comparative | AKP-3000 | 25 | A | IPA/2-pyrrolidone (4:1) | Polymer dispersant 2 | 5.0 | 2.4 | 1.92 | −35 | 52 |
| Example 5 | | | | | | | | | | |
| Comparative | AKP-3000 | 35 | A | IPA/2-pyrrolidone (4:1) | Polymer dispersant 2 | 5.0 | 2.8 | 1.92 | −38 | 51 |
| Example 6 | | | | | | | | | | |
| Example 7 | AKP-3000 | 45 | B | IPA/2-pyrrolidone (4:1) | Polymer dispersant 2 | 5.0 | 1.9 | 1.94 | −37 | 71 |
| Example 8 | AKP-3000 | 50 | B | IPA/2-pyrrolidone (4:1) | Polymer dispersant 2 | 5.0 | 1.8 | 1.91 | −35 | 70 |
| Example 9 | AKP-3000 | 55 | B | IPA/2-pyrrolidone (4:1) | Polymer dispersant 2 | 5.0 | 1.9 | 1.92 | −34 | 71 |
| Comparative | AKP-3000 | 10 | A | IPA/2-pyrrolidone (4:1) | Polymer dispersant 3 | 5.0 | 1.8 | 4.4 | −21 | 63 |
| Example 7 | | | | | | | | | | |
| Comparative | AKP-3000 | 20 | A | IPA/2-pyrrolidone (4:1) | Polymer dispersant 3 | 5.0 | 1.7 | 3.41 | −22 | 63 |
| Example 8 | | | | | | | | | | |
| Example 10 | AKP-3000 | 30 | B | IPA/2-pyrrolidone (4:1) | Polymer dispersant 3 | 5.0 | 1.2 | 4.43 | −21 | 74 |
| Example 11 | AKP-3000 | 40 | B | IPA/2-pyrrolidone (4:1) | Polymer dispersant 3 | 5.0 | 1.1 | 4.41 | −22 | 74 |
| Example 12 | AKP-3000 | 50 | B | IPA/2-pyrrolidone (4:1) | Polymer dispersant 3 | 5.0 | 1.2 | 4.52 | −21 | 72 |
| Comparative | AKP-3000 | 10 | A | IPA/2-pyrrolidone (4:1) | SC-0708A | 5.0 | 2.2 | 1.23 | −22 | 62 |
| Example 9 | | | | | | | | | | |
| Comparative | AKP-3000 | 20 | A | IPA/2-pyrrolidone (4:1) | SC-0708A | 5.0 | 2.1 | 1.22 | −20 | 61 |
| Example 10 | | | | | | | | | | |
| Example 13 | AKP-3000 | 30 | B | IPA/2-pyrrolidone (4:1) | SC-0708A | 5.0 | 1.3 | 1.21 | −21 | 74 |
| Example 14 | AKP-3000 | 40 | B | IPA/2-pyrrolidone (4:1) | SC-0708A | 5.0 | 1.2 | 1.25 | −22 | 75 |
| Example 15 | AKP-3000 | 50 | B | IPA/2-pyrrolidone (4:1) | SC-0708A | 5.0 | 1.3 | 1.16 | −21 | 76 |
| Comparative | PT-301 | 10 | A | IPA/2-pyrrolidone (4:1) | SC-0708A | 5.0 | 1.7 | 1.17 | −22 | 68 |
| Example 11 | | | | | | | | | | |
| Comparative | PT-301 | 20 | A | IPA/2-pyrrolidone (4:1) | SC-0708A | 5.0 | 1.6 | 1.18 | −22 | 67 |
| Example 12 | | | | | | | | | | |
| Example 16 | PT-301 | 30 | B | IPA/2-pyrrolidone (4:1) | SC-0708A | 5.0 | 1.1 | 1.15 | −23 | 81 |
| Example 17 | PT-301 | 40 | B | IPA/2-pyrrolidone (4:1) | SC-0708A | 5.0 | 1.1 | 1.17 | −22 | 78 |
| Example 18 | PT-301 | 50 | B | IPA/2-pyrrolidone (4:1) | SC-0708A | 5.0 | 1.1 | 1.18 | −24 | 77 |

TABLE 2

| | | | | | Polymer dispersant | | | | | |
|---|---|---|---|---|---|---|---|---|---|---|
| | Particles | | | | | Mass | | | | |
| | | Content | Region | | | ratio to | D | | Zeta- | |
| | | [% by | in | | | particles | [×10⁻¹¹ | D₉₀ | potential | L*(1 |
| | Type | mass] | FIG. 1 | Solvent | Type | [%] | m²s⁻¹] | [μm] | [mV] | mg) |
| Comparative | AKP-3000 | 5 | A | IPA/2-pyrrolidone (4:1) | SC-0708A | 3.0 | 1.8 | 1.25 | −21 | 65 |
| Example 13 | | | | | | | | | | |
| Comparative | AKP-3000 | 15 | A | IPA/2-pyrrolidone (4:1) | SC-0708A | 3.0 | 1.7 | 1.22 | −22 | 66 |
| Example 14 | | | | | | | | | | |
| Example 19 | AKP-3000 | 25 | B | IPA/2-pyrrolidone (4:1) | SC-0708A | 3.0 | 0.9 | 1.34 | −20 | 77 |
| Example 20 | AKP-3000 | 35 | B | IPA/2-pyrrolidone (4:1) | SC-0708A | 3.0 | 0.9 | 1.34 | −25 | 78 |
| Example 21 | AKP-3000 | 50 | B | IPA/2-pyrrolidone (4:1) | SC-0708A | 3.0 | 1.1 | 1.33 | −26 | 77 |
| Comparative | AKP-3000 | 10 | A | IPA/2-pyrrolidone (4:1) | SC-0708A | 1.5 | 1.6 | 1.25 | −24 | 67 |
| Example 15 | | | | | | | | | | |
| Example 22 | AKP-3000 | 20 | B | IPA/2-pyrrolidone (4:1) | SC-0708A | 1.5 | 0.9 | 1.41 | −20 | 75 |
| Example 23 | AKP-3000 | 30 | B | IPA/2-pyrrolidone (4:1) | SC-0708A | 1.5 | 0.7 | 1.41 | −22 | 75 |
| Example 24 | AKP-3000 | 40 | B | IPA/2-pyrrolidone (4:1) | SC-0708A | 1.5 | 0.8 | 1.42 | −19 | 76 |
| Example 25 | AKP-3000 | 50 | B | IPA/2-pyrrolidone (4:1) | SC-0708A | 1.5 | 0.9 | 1.41 | −19 | 76 |
| Comparative | AKP-3000 | 10 | A | IPA/HG (4:1) | SC-0708A | 5.0 | 2.2 | 1.23 | −18 | 54 |
| Example 16 | | | | | | | | | | |
| Comparative | AKP-3000 | 20 | A | IPA/HG (4:1) | SC-0708A | 5.0 | 2.3 | 1.23 | −24 | 63 |
| Example 17 | | | | | | | | | | |
| Example 26 | AKP-3000 | 30 | B | IPA/HG (4:1) | SC-0708A | 5.0 | 1.1 | 1.24 | −20 | 76 |
| Example 27 | AKP-3000 | 40 | B | IPA/HG (4:1) | SC-0708A | 5.0 | 1.5 | 1.28 | −20 | 77 |
| Example 28 | AKP-3000 | 50 | B | IPA/HG (4:1) | SC-0708A | 5.0 | 1.4 | 1.29 | −20 | 76 |
| Comparative | AKP-3000 | 10 | A | Ethyl lactate/HG (3:2) | SC-0708A | 5.0 | 2.6 | 0.98 | −20 | 64 |
| Example 18 | | | | | | | | | | |
| Comparative | AKP-3000 | 20 | A | Ethyl lactate/HG (3:2) | SC-0708A | 5.0 | 2.5 | 0.99 | −20 | 65 |
| Example 19 | | | | | | | | | | |
| Comparative | AKP-3000 | 24 | A | Ethyl lactate/HG (3:2) | SC-0708A | 5.0 | 2.6 | 1.01 | −22 | 67 |
| Example 20 | | | | | | | | | | |
| Example 29 | AKP-3000 | 27 | B | Ethyl lactate/HG (3:2) | SC-0708A | 5.0 | 0.9 | 0.95 | −19 | 78 |
| Example 30 | AKP-3000 | 30 | B | Ethyl lactate/HG (3:2) | SC-0708A | 5.0 | 1.1 | 1.01 | −22 | 77 |
| Example 31 | AKP-3000 | 40 | B | Ethyl lactate/HG (3:2) | SC-0708A | 5.0 | 1.2 | 1.03 | −26 | 77 |
| Example 32 | AKP-3000 | 50 | B | Ethyl lactate/HG (3:2) | SC-0708A | 5.0 | 1.1 | 1.02 | −19 | 76 |
| Comparative | AKP-3000 | 10 | A | MEK/HG (4:1) | SC-0708A | 5.0 | 2.2 | 1.23 | −20 | 65 |
| Example 21 | | | | | | | | | | |
| Comparative | AKP-3000 | 20 | A | MEK/HG (4:1) | SC-0708A | 5.0 | 2.4 | 1.25 | −22 | 64 |
| Example 22 | | | | | | | | | | |
| Comparative | AKP-3000 | 30 | A | MEK/HG (4:1) | SC-0708A | 5.0 | 2.1 | 1.22 | −20 | 61 |
| Example 23 | | | | | | | | | | |
| Example 33 | AKP-3000 | 40 | B | MEKHG (4:1) | SC-0708A | 5.0 | 1.2 | 1.23 | −20 | 78 |
| Example 34 | AKP-3000 | 50 | B | MEKHG (4:1) | SC-0708A | 5.0 | 1.3 | 1.21 | −23 | 76 |
| Comparative | AKP-3000 | 10 | A | DAA | SC-0708A | 5.0 | 2.2 | 1.13 | −20 | 61 |
| Example 24 | | | | | | | | | | |
| Comparative | AKP-3000 | 20 | A | DAA | SC-0708A | 5.0 | 2.4 | 1.12 | −23 | 62 |
| Example 25 | | | | | | | | | | |
| Example 35 | AKP-3000 | 30 | B | DAA | SC-0708A | 5.0 | 1.2 | 1.14 | −26 | 78 |
| Example 36 | AKP-3000 | 40 | B | DAA | SC-0708A | 5.0 | 1.1 | 1.15 | −22 | 77 |
| Example 37 | AKP-3000 | 50 | B | DAA | SC-0708A | 5.0 | 1.3 | 1.11 | −20 | 76 |

TABLE 3

| | | | | | Polymer dispersant | | | | | |
|---|---|---|---|---|---|---|---|---|---|---|
| | Particles | | | | | Mass | | | | |
| | | Content | Region | | | ratio to | D | | Zeta- | |
| | | [% by | in | | | particles | [×10⁻¹¹ | D₉₀ | potential | L*(1 |
| | Type | mass] | FIG. 1 | Solvent | Type | [%] | m²s⁻¹] | [μm] | [mV] | mg) |
| Comparative | AKP-3000 | 10 | A | DAA/HG (4:1) | SC-0708A | 5.0 | 1.9 | 1.15 | −20 | 66 |
| Example 26 | | | | | | | | | | |
| Comparative | AKP-3000 | 20 | A | DAA/HG (4:1) | SC-0708A | 5.0 | 1.8 | 1.17 | −22 | 65 |
| Example 27 | | | | | | | | | | |
| Example 38 | AKP-3000 | 30 | B | DAA/HG (4:1) | SC-0708A | 5.0 | 1.8 | 1.11 | −20 | 74 |
| Example 39 | AKP-3000 | 40 | B | DAA/HG (4:1) | SC-0708A | 5.0 | 1.0 | 1.19 | −22 | 78 |
| Example 40 | AKP-3000 | 50 | B | DAA/HG (4:1) | SC-0708A | 5.0 | 0.9 | 1.13 | −26 | 77 |
| Comparative | AKP-3000 | 10 | — | Ethyl lactate | SC-0708A | 5.0 | 2.8 | 0.92 | −20 | 65 |
| Example 28 | | | | | | | | | | |
| Comparative | AKP-3000 | 20 | — | Ethyl lactate | SC-0708A | 5.0 | 2.5 | 0.91 | −24 | 66 |
| Example 29 | | | | | | | | | | |
| Comparative | AKP-3000 | 30 | — | Ethyl lactate | SC-0708A | 5.0 | 2.1 | 0.98 | −26 | 67 |
| Example 30 | | | | | | | | | | |
| Comparative | AKP-3000 | 40 | — | Ethyl lactate | SC-0708A | 5.0 | 1.8 | 0.99 | −24 | 67 |
| Example 31 | | | | | | | | | | |
| Comparative | AKP-3000 | 50 | — | Ethyl lactate | SC-0708A | 5.0 | 1.5 | 1.01 | −22 | 67 |
| Example 32 | | | | | | | | | | |
| Example 41 | LS-10 | 10.0 | B | IPA/2-pyrrolidone (4:1) | SC-0708A | 5.0 | 1.5 | 5.12 | −19 | 79 |
| Example 42 | LS-10 | 20.0 | B | IPA/2-pyrrolidone (4:1) | SC-0708A | 5.0 | 1.4 | 5.13 | −22 | 78 |
| Comparative | LS-10 | 30.0 | A | IPA/2-pyrrolidone (4:1) | SC-0708A | 5.0 | 1.1 | 5.11 | −22 | 67 |
| Example 33 | | | | | | | | | | |
| Comparative | LS-10 | 40.0 | A | IPA/2-pyrraliclane (4:1) | SC-0708A | 5.0 | 1.2 | 5.09 | −24 | 65 |
| Example 34 | | | | | | | | | | |
| Comparative | LS-10 | 50.0 | A | IPA/2-pyrrolidone (4:1) | SC-0708A | 5.0 | 1.1 | 5.08 | −23 | 66 |
| Example 35 | | | | | | | | | | |

From Tables 1 to 3, the liquid compositions in Examples 1 to 42 have L*(1 mg) of 70 or greater, and the permeability of the liquid compositions to the coating medium is low.

In contrast, the liquid compositions in Comparative Examples 1 to 27, 33 to 35 have L* (1 mg) of less than 70 because the content of the particles is within the range of region A illustrated in FIG. 1. As a result, the permeability of the liquid compositions to the coating medium is high.

Also, the liquid compositions in Comparative Examples 28 to 32 have L*(1 mg) of less than 70 because the diffusion coefficient decreases linearly as the content of the particles increases. As a result, the permeability of the liquid compositions to the coating medium is high.

In consideration of manufacturing a separator-integrated electrode, when L*(1 mg) is 70 or greater, a manufacturing of a separator-integrated electrode can be achieved.

Although, some image defects were observed in the liquid compositions of Examples 41 and 42, L*(1 mg) was 70 or greater because the D₉₀ of Examples 41 and 42 were 5.12 μm and 5.13 μm, respectively.

The dynamic and static viscosities of the liquid compositions in Examples 29 to 32 were measured to infer the structure of particles upon discharge of the liquid compositions.

Table 4 indicates the measurement results of the dynamic and static viscosities of the liquid compositions in Examples 29 to 32.

TABLE 4

| | Dynamic | Static viscosity | Static viscosity |
|---|---|---|---|
| | viscosity | (Quick stop) | (Re-rotate) |
| | [mPa · s] | [mPa · s] | [mPa · s] |
| Example 29 | 13 | <1 | 18 |
| Example 30 | 12 | <1 | 16 |
| Example 31 | 14 | <1 | 18 |
| Example 32 | 13 | <1 | 21 |

If the diffusion coefficient D of the liquid composition is large and it is assumed that the structure of particles is present, it is generally expected that the static viscosity of the liquid composition would be high.

However, as illustrated in Table 4, the liquid compositions in Examples 29 to 32 have low dynamic viscosity and static viscosity (quick stop), but have high static viscosity (re-rotate). Thus, it is assumed that the particles in the liquid compositions of Examples 29 to 32 are individually dispersed under high shear forces, or close to the state in which the liquid compositions are individually dispersed. In contrast, the particles are assumed to form a structure under stationary state.

Since it is difficult to measure viscosity smaller than the measurement limit of DV-II+Pro Viscometer (manufactured by Brookfield Engineering Laboratories, Inc.), the static viscosity (quick stop) of the liquid compositions in Examples 29 to 32 is indicated as less than 1.0 mPa·s.

What is claimed is:

1. A liquid composition comprising:
particles; and
a solvent,
wherein a diffusion coefficient of the liquid composition decreases in one step-shaped curve through a single inflection point as content of the particles increases, and
wherein the content of the particles is greater than or equal to the content of the particles at the inflection point.

2. The liquid composition according to claim 1, wherein a particle diameter corresponding to 90% is 5 μm or less.

3. The liquid composition according to claim 1, wherein an absolute value of a zeta-potential is 30 mV or less.

4. The liquid composition according to claim 1, further comprising a resin having an acid anhydride group.

5. The liquid composition according to claim 1, wherein the particles are aluminum oxide particles.

6. A method of discharging liquid, comprising: discharging the liquid composition of claim 1.

7. A method of manufacturing an electrode, comprising:
forming an electrode composite material layer on an electrode substrate; and
discharging the liquid composition of claim 1 onto the electrode composite material layer to form a particle layer.

8. A method of manufacturing an electrochemical device comprising:
manufacturing an electrode by the method of claim 7.
